(19) United States
(12) Patent Application Publication
(10) Pub. No.: US 2023/0273746 A1
(43) Pub. Date: Aug. 31, 2023

(54) STORAGE SYSTEM, PATH CONTROL METHOD, AND NON-TRANSITORY COMPUTER-READABLE MEDIUM

(71) Applicant: Hitachi, Ltd., Tokyo (JP)

(72) Inventors: Masahiro IDE, Tokyo (JP); Shinichi HIRAMATSU, Tokyo (JP); Masaru TSUKADA, Tokyo (JP)

(73) Assignee: Hitachi, Ltd., Tokyo (JP)

(21) Appl. No.: 17/900,072

(22) Filed: Aug. 31, 2022

(30) Foreign Application Priority Data
Feb. 28, 2022 (JP) 2022-028913

(51) Int. Cl. G06F 3/06

(52) U.S. Cl. CPC G06F 3/0655; G06F 3/0604; G06F 3/0679

(57) ABSTRACT

A storage system comprises a plurality of controllers and a plurality of drives, is coupled to a host via a plurality of physical paths, provides the host with a volume including storage areas of the plurality of drives. One controller out of the plurality of controllers sets, to any one of the plurality of controllers, ownership which is a right to control IO to and from the volume; and notifies, to the host, one of the plurality of physical paths that is coupled to one of the plurality of controllers to which the ownership is set, as a priority path for transmitting an IO request.

### CLAIM OF PRIORITY

The present application claims priority from Japanese patent application JP 2022-28913 filed on Feb. 28, 2022, the content of which is hereby incorporated by reference into this application.

### BACKGROUND

This invention relates to path control of a storage system.

In recent years, scale-out storage systems which can inexpensively be scaled up in capacity and performance are becoming popular. A storage system includes a plurality of controllers (CTLs) and a plurality of storage media, and provides a storage area generated from the plurality of storage media to a host. The CTLs process input/output (IO) between the storage area and the host. The host manages physical paths for coupling to the provided storage area. With a change in a configuration of the storage system such as scaling out, the physical paths increase or decrease in number.

An upper limit to the number of physical paths is determined by what type of operating system (OS) is used. Accordingly, when the number of physical paths exceeds the upper limit to how many physical paths can be set, settings of the physical paths are required to be manually corrected. A technology as described in JP 2018-156144 A is known to address this issue.

In JP 2018-156144 A, there is included description “A storage device is a device included in a storage system. The storage device includes a host management table for managing information about logical paths between the storage system and a host device, a coupling path management module, and a logical path deletion notification module. The coupling path management module refers to the host management table when another storage device is added to the storage system, to thereby select a logical path to be deleted out of the logical paths between the storage system and the host device. The logical path deletion notification module notifies the selected logical path to the host device.”

### SUMMARY

The host can set a plurality of physical paths between the host and the storage system for such purposes as failure resistance and load distribution. To access the provided storage area, the host selects one physical path out of the plurality of physical paths, and accesses the storage area via the selected physical path. With the related art, the physical path is selected by round-robin.

In the storage system, ownership for processing IO to and from the storage area can be set to one CTL. In a case where one of the CTLs that has received an IO request does not have the ownership, the IO request is forwarded to another of the CTLs that has the ownership. In this case, there is a problem in that response to IO processing is delayed.

It is an object of this invention to provide a storage system for assisting a host so that the host can use a physical path along which performance of IO processing is high.

A representative example of the present invention disclosed in this specification is as follows: a storage system comprises a plurality of controllers and a plurality of drives. The storage system is coupled to a host via a plurality of physical paths, and provides the host with a volume including storage areas of the plurality of drives. One controller out of the plurality of controllers being configured to: set, to any one of the plurality of controllers, ownership which is a right to control IO to and from the volume; and notify, to the host, one of the plurality of physical paths that is coupled to one of the plurality of controllers to which the ownership is set, as a priority path for transmitting an IO request.

According to the at least one embodiment of this invention, the host can use the physical path along which the performance of IO processing is high. Other problems, configurations, and effects than those described above will become apparent in the descriptions of embodiments below.

### BRIEF DESCRIPTION OF THE DRAWINGS

The present invention can be appreciated by the description which follows in conjunction with the following figures, wherein:

FIG. 1 is a diagram for illustrating a configuration example of a system in a first embodiment of this invention;

FIG. 2 is a diagram for illustrating an example of logical coupling of the system in the first embodiment;

FIG. 3A and FIG. 3B are tables for showing an example of a data structure of configuration management information in the first embodiment;

FIG. 4 is a table for showing an example of a data structure of LDEV owner management information in the first embodiment;

FIG. 5 is a table for showing an example of a data structure of priority path management information in the first embodiment;

FIG. 6 is a flow chart for illustrating an example of priority path notification processing executed by a storage system of the first embodiment;

FIG. 7 is a flow chart for illustrating an example of priority path setting processing executed by a host in the first embodiment

FIG. 8 is a flow chart for illustrating an example of priority path failure handling processing executed by the storage system of the first embodiment;

FIG. 9 is a flow chart for illustrating an example of CTL failure handling processing executed by the storage system of the first embodiment;

FIG. 10 is a flow chart for illustrating an example of ownership transfer processing executed by the storage system of the first embodiment; and

FIG. 11A and FIG. 11B are flow charts for illustrating an example of MPU load handling processing executed by the storage system of the first embodiment.

### DETAILED DESCRIPTION OF THE PREFERRED EMBODIMENTS

Now, description is given of at least one embodiment of this invention referring to the drawings. It should be noted that this invention is not to be construed by limiting the invention to the content described in the following at least one embodiment. A person skilled in the art would easily recognize that specific configurations described in the following at least one embodiment may be changed within the scope of the concept and the gist of this invention.

In the following description, “table,” “list,” “queue,” and similar expressions may be used to describe information of various types, but the information of various types may be expressed by data structures other than those. In order to indicate independency on data structure, “XX table,” “XX list,” and the like may be referred to as “XX information.” Description on contents of each type of information uses one or more expressions out of “identification information,” “identifier,” “name,” “ID,” “number,” and similar expressions, which are interchangeable.

In configurations of the at least one embodiment of this invention described below, the same or similar components or functions are denoted by the same reference numerals, and a redundant description thereof is omitted here.

Notations of, for example, “first”, “second”, and “third” herein are assigned to distinguish between components, and do not necessarily limit the number or order of those components.

The position, size, shape, range, and others of each component illustrated in, for example, the drawings may not represent the actual position, size, shape, range, and others in order to facilitate understanding of this invention. Thus, this invention is not limited to the position, size, shape, range, and others disclosed in, for example, the drawings.

### First Embodiment

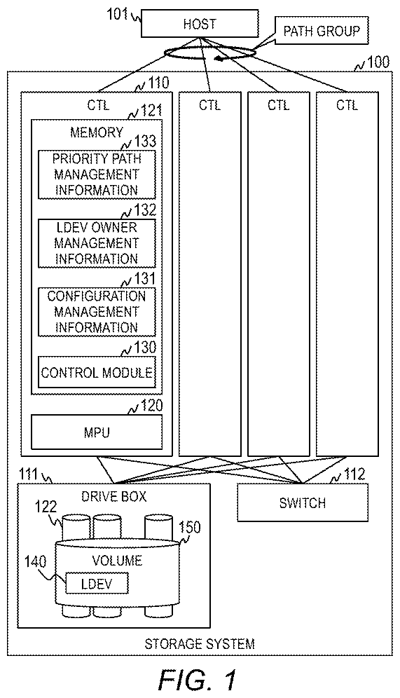

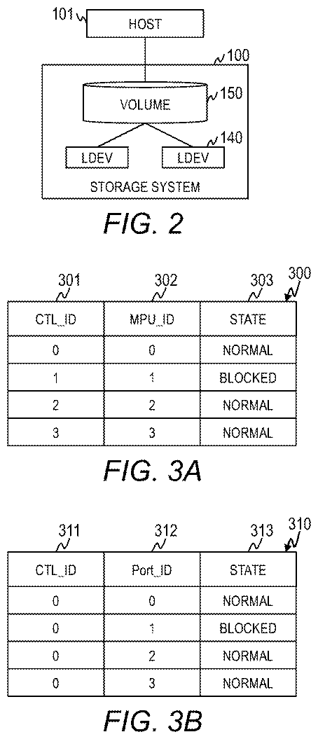

FIG. 1 is a diagram for illustrating a configuration example of a system in a first embodiment of this invention. FIG. 2 is a diagram for illustrating an example of logical coupling of the system in the first embodiment.

The system of FIG. 1 includes a storage system 100 and a host 101. The host 101 is coupled to the storage system 100 via a network (not shown), such as a wide area network (WAN), a local area network (LAN), or a storage area network (SAN). For the coupling via the network, any method out of a wired coupling method and a wireless coupling method may be used.

The host 101 is a computer, such as a mainframe computer or a general-purpose computer, that uses the storage system 100. The host 101 is coupled to the storage system 100 via a plurality of physical paths in the network. The host 101 has a function of managing the plurality of physical paths as a path group forming a single logical path. As illustrated in FIG. 2, the host 101 is coupled via the logical path to a volume 150 to which one or more LDEVs 140 are allocated, to write data and read data. Unless particularly specified by the storage system 100, the host 101 selects, by round-robin, one of the plurality of physical paths forming the logical path, and transmits an IO request to the selected physical path.

The storage system 100 provides the volume 150 to the host 101. The storage system 100 generates, from a plurality of drives 122, a parity group (PG), which forms redundant arrays of inexpensive disks (RAID), and generates one or more LDEVs 140 from the PG. The storage system 100 allocates one or more LDEVs 140 to the volume 150. The drives 122 are, for example, hard disk drives (HDDs), solid state drives (SSDs), or the like.

The storage system 100 includes a plurality of controllers (CTLs) 110, a drive box 111, and a switch 112.

The CTLs 110 control transmission and reception of data between the host 101 and the volume 150, and also control IO to and from the volume 150. A hardware configuration of the CTLs 110 includes an MPU 120 and a memory 121. The CTLs 110 each include, among others, a channel board (CHB) and a disk board (DKB), which are omitted from the drawing. A function configuration of the CTLs 110 includes a control module 130 which controls data transmission and reception and IO of data. The CTLs 110 each hold configuration management information 131, LDEV owner management information 132, and priority path management information 133 as well.

The switch 112 is a switch for coupling the plurality of CTLs 110. The drive box 111 is a casing in which the plurality of drives 122 are mounted.

FIG. 3A and FIG. 3B are tables for showing an example of a data structure of the configuration management information 131 in the first embodiment.

The configuration management information 131 stores a table 300 and a table 310. The table 300 is a table for managing states of the CTLs 110. The table 310 is a table for managing coupling states of paths.

Each entry stored in the table 300 includes fields for a CTL_ID 301, an MPU_ID 302, and a state 303. The table 300 has one entry for one CTL out of the plurality of CTLs 110. Fields included in each entry are not limited to those described above.

The field for the CTL_ID 301 stores identification information of one of the CTLs 110. The field for the MPU_ID 302 stores identification information of the MPU 120. The field for the state 303 stores a value indicating a state of the one of the CTLs 110. The field for the state 303 in the first embodiment stores one value out of “normal” indicating that the CTL is running normally and “blocked” indicating that the CTL is blocked.

Each entry stored in the table 310 includes fields for a CTL_ID 311, a Port_ID 312, and a state 313. The table 310 has one entry for one combination of one CTL out of the plurality of CTLs 110 and a port (not shown) of the one of the CTLs 110. Fields included in each entry are not limited to those described above.

The field for the CTL_ID 311 stores identification information of one of the CTLs 110. The field for the Port_ID 312 stores identification information of a port of the one of the CTLs 110. The field for the state 313 stores a value indicating a coupling state of a physical path coupled via the port. The field for the state 313 in the first embodiment stores one value out of “normal” indicating that the physical path is coupled normally and “blocked” indicating that the physical path is blocked.

The configuration management information 131 includes a table for managing the PG, the LDEVs, and the like, but the table is omitted from the drawing. This table stores, for example, information about an association relationship of the PG, the one or more LDEVs, and the volume.

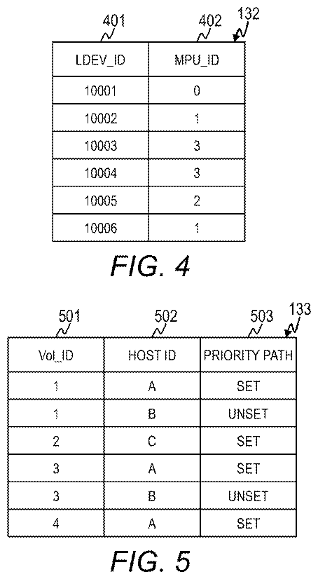

FIG. 4 is a table for showing an example of a data structure of the LDEV owner management information 132 in the first embodiment.

The LDEV owner management information 132 is information for managing ownership for specifying which one of the plurality of CTLs 110 is to process IO to and from one of the one or more LDEVs 140. Each entry stored in the LDEV owner management information 132 includes fields for an LDEV_ID 401 and an MPU_ID 402. The LDEV owner management information 132 has one entry for one LDEV out of the one or more LDEVs 140. Fields included in each entry are not limited to those described above.

The field for the LDEV_ID 401 stores identification information of one of the one or more LDEVs 140. The field for the MPU_ID 402 stores identification information of the MPU 120 of one CTL to which the ownership is set out of the plurality of CTLs 110.

FIG. 5 is a table for showing an example of a data structure of the priority path management information 133 in the first embodiment.

The priority path management information 133 is information for managing a priority path setting state. Each entry stored in the priority path management information 133 includes fields for a Vol_ID 501, a host ID 502, and a priority path 503. The priority path management information 133 has one entry for one combination of the volume 150 and the host 101. Fields included in each entry are not limited to those described above.

The field for Vol_ID 501 stores identification information of the volume 150. The field for the host ID 502 stores identification information of the host 101. The field for the priority path 503 stores a value indicating a setting state of a priority path to be used when the host 101 accesses the volume 150. The field for the priority path 503 in the first embodiment stores one value out of “set” indicating that the priority path is already set and “unset” indicating that the priority path is not set yet.

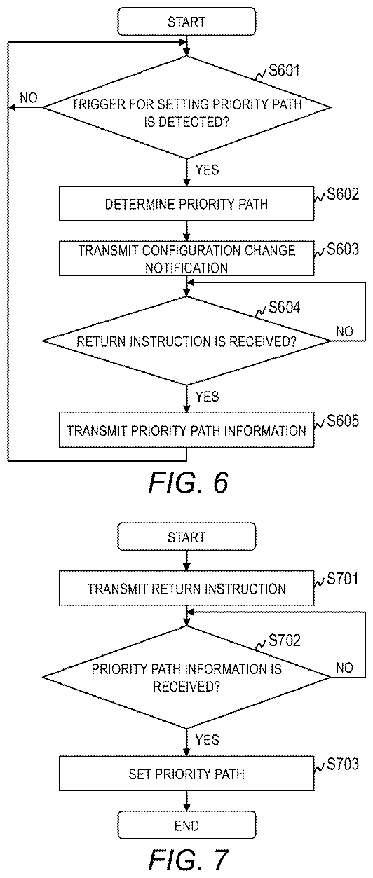

FIG. 6 is a flow chart for illustrating an example of priority path notification processing executed by the storage system 100 of the first embodiment. A premise here is that the control module 130 of one of the CTLs 110 of the storage system 100 executes the priority path notification processing. It may be determined in advance which one of the CTLs 110 is to execute the priority path notification processing.

The control module 130 starts the priority path notification processing after being activated. The control module 130 determines whether a trigger for setting the priority path has been detected (Step S601). In the first embodiment, it is determined whether an execution flag is “ON”. In a case where the execution flag is “ON,” the control module 130 determines that a trigger for setting the priority path has been detected.

The execution flag is set to “ON” in a case where an event, such as generation of the volume 150, coupling of a physical path, or a failure in a physical path, has occurred. The execution flag is associated with identification information of the host 101 that is a target. A premise here is that identification information of one host 101 is associated with the execution flag.

In a case where it is determined that a trigger for setting the priority path has not been detected, the process returns to Step S601 and the control module 130 monitors for a trigger for setting the priority path.

In a case where it is determined that a trigger for setting the priority path has been detected, the control module 130 determines the priority path for the combination of the host 101 and the volume 150 (Step S602).

Specifically, the control module 130 identifies, based on the configuration management information 131, each one of the one or move LDEVs 140 that form the volume 150, and identifies, based on the LDEV owner management information 132, the MPU 120 to which ownership of the identified one of the one or more LDEVs 140 is set. The control module 130 determines a physical path coupling one of the plurality of CTLs 110 in which the identified MPU 120 is installed and the host 101 as the priority path.

The control module 130 transmits, to the host 101, a configuration change notification for notifying the priority path (Step S603). The priority path may be notified by, for example, using an existing command for notifying a change in a state of the storage system 100. The host 101 receives the configuration change notification and executes priority path setting processing. Details of the priority path setting processing are described later with reference to FIG. 7.

The control module 130 determines whether a return instruction has been received from the host 101 (Step S604).

In a case where it is determined by the control module 130 that the return instruction has not been received from the host 101, the process returns to Step S604 after a predetermined length of time elapses.

In a case where it is determined that the return instruction has been received, the control module 130 transmits priority path information (Step S605), and the process subsequently returns to Step S601. For example, an existing command may be used to notify that a physical path coupled to one of the plurality of CTLs 110 that executes the control module 130 is the priority path. At this point, the control module 130 changes the execution flag to “OFF.”

In a case where identification information of more than one host 101 is associated with the execution flag, processing steps of from Step S602 to Step S605 are executed for each host 101.

FIG. 7 is a flow chart for illustrating an example of the priority path setting processing executed by the host 101 in the first embodiment.

The host 101 starts the priority path setting processing in a case where the configuration change notification for notifying the priority path is received.

The host 101 transmits the return instruction to the storage system 100 (Step S701).

The host 101 determines whether the priority path information has been received from the storage system 100 (Step S702).

In a case where it is determined by the host 101 that the priority path information has not been received from the storage system 100, the process returns to Step S702 after a predetermined length of time elapses.

In a case where it is determined that the priority path information has been received from the storage system 100, the host 101 sets the priority path based on the priority path information (Step S703).

Through the processing described with reference to FIG. 6 and the processing described with reference to FIG. 7, settings that enable the host 101 to preferentially use a physical path along which IO processing performance is high can be set.

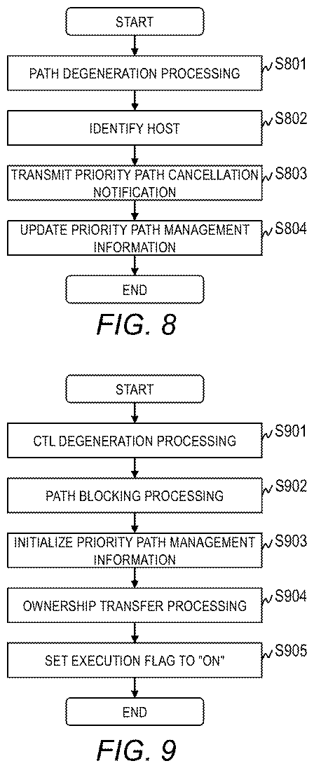

FIG. 8 is a flow chart for illustrating an example of priority path failure handling processing executed by the storage system 100 of the first embodiment.

In a case where a failure in a physical path due to a trouble with a cable or the like is detected, the control module 130 executes path degeneration processing (Step S801). The path degeneration processing is a publicly known technology and, for example, the control module 130 shuts off communication along the physical path in which the failure has occurred, to thereby interrupt IO processing that is being executed, and frees up a memory area and other internal resources that have been used in the IO processing. In a case where the host 101 has detected that communication along that physical path is unavailable, the host 101 retries communication along another physical path in the path group.

The control module 130 identifies the host 101 (target host 101) for which the failed physical path is set as the priority path (Step S802).

Specifically, the control module 130 refers to the table 310 to identify one of the plurality of CTLs 110 that is coupled to the failed physical path, and refers to the table 300 to identify the MPU 120 installed in the identified one of the CTLs 110. The control module 130 refers to the LDEV owner management information 132 to identify one of the one or more LDEVs 140 that is associated with the identified MPU 120 in a sense that ownership of the LDEV belongs to the identified MPU 120. The control module 130 further refers to the configuration management information 131 to identify the volume 150 to which the identified one of the one or more LDEVs 140 is allocated. The control module 130 refers to the priority path management information 133 to search for an entry in which identification information of the identified volume 150 is set as the Vol_ID 501 and the value “set” is set as the priority path 503. The control module 130 identifies, as the target host 101, the host 101 that has the host ID 502 of the entry found as a result of the search.

The control module 130 transmits a priority path cancellation notification to the identified host 101 (Step S803). The host 101 receiving this notification invalidates priority path settings. To transmit an IO request, the host 101 selects one physical path by round-robin.

The control module 130 updates the priority path management information 133 (Step S804).

Specifically, the control module 130 sets the value “unset” to the priority path 503 of the entry found in Step S802 as a result of the search.

Through the processing described above, priority path settings can be changed to suit the state of the physical path.

FIG. 9 is a flow chart for illustrating an example of CTL failure handling processing executed by the storage system 100 of the first embodiment.

In a case where a failure due to a trouble with a hardware component or the like is detected in one of the plurality of CTLs 110, the control module 130 of the one of the plurality of CTLs 110 executes CTL degeneration processing (Step S901). The degeneration processing of the one of the plurality of CTLs 110 is a publicly known technology and, for example, the control module 130 interrupts processing that is being executed in the one of the plurality of CTLs 110 and resets cache data. The control module 130 further searches the table 300 of the configuration management information 131 for an entry storing identification information of the one of the plurality of CTLs 110 as the CTL_ID 301, sets the state 303 of the entry to “degenerated,” and notifies that the one of the plurality of CTLs 110 is degenerated to the other CTLs 110.

Next, the control module 130 executes blocking processing for a physical path coupled to the one of the plurality of CTLs 110 (Step S902). The processing of blocking the physical path is a publicly known technology and, for example, the control module 130 shuts off communication coupling of the physical path coupled via a port of the one of the plurality of CTLs 110, issues a request to interrupt IO processing to the host 101 that is coupled via this port, and thus stops subsequent IO processing and data communication. The control module 130 further identifies identification information of the port to which the physical path to be blocked is coupled, searches the table 310 of the configuration management information 131 for an entry in which the identification information of this port is stored as the Port_ID 312, and sets the state 313 of the entry to “blocked.”

The control module 130 initializes the priority path management information 133 (Step S903).

Specifically, the control module 130 sets the value “unset” to the priority path 503 in every entry.

The control module 130 executes processing of transferring ownership set to the MPU 120 of the failed one of the plurality of CTLs 110 (Step S904).

In the processing of transferring the ownership, the control module 130 searches the table 300 of the configuration management information 131 for every entry in which the state 303 is “normal,” identifies the CTLs 110 that have identification information stored as the CTL_ID 301 in any of the entries found through the search, and determines, from among those CTLs 110, a destination to which the ownership is to be transferred. One of the plurality of CTLs 110 that is the transfer destination is determined based on, for example, load (a cache utilization amount, an IO processing amount, or the like). For example, one of the plurality of CTLs 110 that is lightest in load is determined as the transfer destination. The control module 130 further identifies an entry of the LDEV owner management information 132 in which identification information of the MPU 120 of the failed one of the plurality of CTLs 110 is set as the MPU_ID 402, and sets identification information of the MPU 120 of the one of the plurality of CTLs 110 that is the ownership transfer destination as the MPU_ID 402 of the identified entry.

To give another example of steps, the control module 130 may execute the ownership transfer processing for each one of the one or more LDEVs 140. In this case, the control module 130 may identify an entry of the LDEV owner management information 132 in which identification information of the MPU 120 of the failed one of the plurality of CTLs 110 is set as the MPU_ID 402, and in which identification information of the one of the one or more LDEVs 140 that is a target is set as the LDEV_ID 401, and set identification information of the MPU 120 of the one of the plurality of CTLs 110 that is the ownership transfer destination as the MPU_ID 402 of the identified entry.

The control module 130 sets the execution flag to “ON” (Step S905). At this point, the control module 130 associates identification information of every host 101 registered in the priority path management information 133 with the execution flag.

Through the processing described above, priority path settings can be changed to suit the states of the CTLs 110.

Although a case in which the control module 130 of the failed one of the plurality of CTLs 110 executes the CTL failure handling processing is illustrated in FIG. 9, the control module 130 of another one of the plurality of CTLs 110 that is operating normally may execute the CTL failure handling processing in place of the control module 130 of the failed CTL. In this case, the control module 130 of each one of the plurality of CTLs 110 may regularly monitor an operation situation of another one of the plurality of CTLs 110 via the switch 112, to determine occurrence of a failure from the operation situation, or issue alert to the effect that a failure has occurred so that one of the plurality of CTLs 110 in which the failure has occurred is identified by detection of the alert.

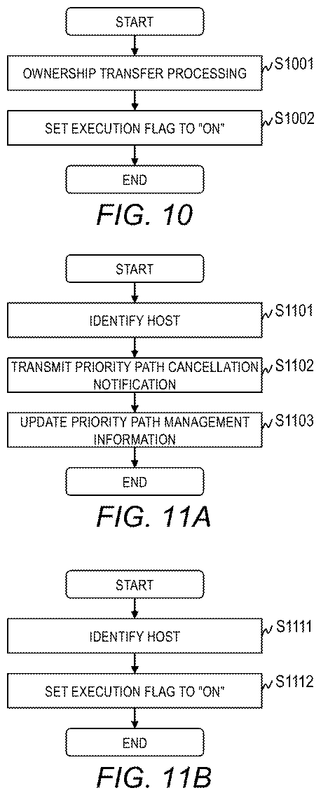

FIG. 10 is a flow chart for illustrating an example of the ownership transfer processing executed by the storage system 100 of the first embodiment.

The control module 130 receives an instruction to transfer ownership from the host 101, and executes the ownership transfer processing in accordance with the instruction (Step S1001). The ownership transfer processing is the same as Step S904 of FIG. 9, and description thereof is accordingly omitted. In this case also, the ownership transfer destination is determined in the storage system 100, and the host 101 is accordingly not required to specify one of the plurality of CTLs 110 as the ownership transfer destination when issuing the transfer instruction.

The control module 130 sets the execution flag to “ON” (Step S1002). At this point, the control module 130 associates identification information of the host 101 that has transmitted the instruction with the execution flag. This is accompanied by execution of the priority path notification processing by the control module 130 through the steps illustrated in FIG. 6. The host 101 receiving the configuration change notification for notifying the priority path executes the priority path setting processing through the steps illustrated in FIG. 7.

Through the processing described above, priority path settings can be changed following a transfer of ownership.

FIG. 11A and FIG. 11B are flow charts for illustrating an example of MPU load handling processing executed by the storage system 100 of the first embodiment. In the MPU load handling processing described below, cancellation of a priority path and switching of a priority path are executed depending on a load situation of the MPU 120 of one of the plurality of CTLs 110 to which a priority path is set.

In a case where an increase in load of the MPU 120 is detected, processing of FIG. 11A is executed.

The control module 130 identifies the host 101 (target host 101) to which a priority path related to one of the one or more LDEVs 140 that is associated with the MPU 120 increased in load in the sense that ownership of the LDEV belongs to the MPU 120 is set (Step S1101).

Specifically, the control module 130 refers to the LDEV owner management information 132 to identify one of the one or more LDEVs 140 that is associated with the MPU 120 increased in load in the sense that ownership of the LDEV belongs to the MPU 120. The control module 130 further refers to the configuration management information 131 to identify the volume 150 to which the identified one of the one or more LDEVs 140 is allocated. The control module 130 refers to the priority path management information 133 to search for an entry in which identification information of the identified volume 150 is set as the Vol_ID 501, and in which the value “set” is set to the priority path 503. The control module 130 identifies, as the target host 101, the host 101 that has identification information matching the host ID 502 of the entry found as a result of the search.

The control module 130 transmits a priority path cancellation notification to the identified host 101 (Step S1102). The host 101 receiving this notification invalidates priority path settings. To transmit an IO request, the host 101 selects one physical path by round-robin.

The control module 130 updates the priority path management information 133 (Step S1103).

Specifically, the control module 130 sets the value “unset” to the priority path 503 of the entry found in Step S1101 as a result of the search.

Through the processing described above, a path to be used can be changed to accommodate an increase in the load of the MPU 120.

In a case where a decrease in load of the MPU 120 is detected, processing of FIG. 11B is executed.

The control module 130 identifies the target host 101 (Step S1111).

Specifically, the control module 130 refers to the LDEV owner management information 132 to identify one of the one or more LDEVs 140 that is associated with the MPU 120 decreased in load in the sense that ownership of the LDEV belongs to the MPU 120. The control module 130 further refers to the configuration management information 131 to identify the volume 150 to which the identified one of the one or more LDEVs 140 is allocated. The control module 130 refers to the priority path management information 133 to search for an entry in which identification information of the identified volume 150 is set as the Vol_ID 501, and in which the value “unset” is set to the priority path 503. The control module 130 identifies, as the target host 101, the host 101 that has identification information matching the host ID 502 of the entry found as a result of the search.

The control module 130 sets the execution flag to “ON” (Step S1112). At this point, the control module 130 associates the identification information of the target host 101 with the execution flag. This is accompanied by execution of the priority path notification processing by the control module 130 through the steps illustrated in FIG. 6.

Through the processing described above, the priority path can be set to accommodate a decrease in the load of the MPU 120.

As described above, according to the first embodiment, the storage system 100 notifies a physical path along which IO processing performance is high to the host 101 so that the physical path is set as a priority path. This enables the host 101 to use a physical path along which IO processing performance is high, without increasing operation load on the user.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, Python and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A storage system, comprising a plurality of controllers and a plurality of drives,
the storage system being configured to be coupled to a host via a plurality of physical paths,
the storage system being configured to provide the host with a volume including storage areas of the plurality of drives,
one controller out of the plurality of controllers being configured to:
set, to any one of the plurality of controllers, ownership which is a right to control IO to and from the volume; and
notify, to the host, one of the plurality of physical paths that is coupled to one of the plurality of controllers to which the ownership is set, as a priority path for transmitting an IO request.

2. The storage system according to claim 1, wherein, in a case where one of the plurality of controllers to which the ownership is set is changed to another of the plurality of controllers, the one controller out of the plurality of controllers is configured to notify, to the host, as the priority path, one of the plurality of physical paths that is coupled to the another of the plurality of controllers to which the ownership is newly set.

3. The storage system according to claim 1,
wherein the storage system is configured to hold priority path management information for managing an association relationship between the host and the priority path, and
wherein the one controller out of the plurality of controllers is configured to:
identify, in a case where a failure occurs in one of the plurality of physical paths, based on the priority path management information, the host to which the failed physical path is set as the priority path; and
notify cancellation of setting of the priority path to the identified host.

4. The storage system according to claim 1,
wherein the storage system is configured to hold priority path management information for managing an association relationship between the host and the priority path, and
wherein the one controller out of the plurality of controllers is configured to:
identify, in a case where one of the plurality of controllers is detected as a controller increased in load, based on the priority path management information, the host to which one of the plurality of physical paths that is coupled to the controller increased in load is set as the priority path; and
notify cancellation of setting of the priority path to the identified host.

5. The storage system according to claim 1,
wherein the storage system is configured to hold priority path management information for managing an association relationship between the host and the priority path, and
wherein the one controller out of the plurality of controllers is configured to:
identify, in a case where one of the plurality of controllers is detected as a controller decreased in load, based on the priority path management information, the host that accesses the volume for which the controller decreased in load has the ownership and that has no priority path set thereto; and
notify, to the identified host, one of the plurality of physical paths that is coupled to the controller decreased in load as the priority path.

6. A path control method, which is executed by a storage system including a plurality of controllers and a plurality of drives,
the storage system being configured to be coupled to a host via a plurality of physical paths,
the storage system being configured to provide the host with a volume including storage areas of the plurality of drives,
the path control method including:
setting, by one controller out of the plurality of controllers, to any one of the plurality of controllers, ownership which is a right to control IO to and from the volume; and
notifying, by the one controller out of the plurality of controllers, to the host, one of the plurality of physical paths that is coupled to one of the plurality of controllers to which the ownership is set, as a priority path for transmitting an IO request.

7. A non-transitory computer-readable medium having stored thereon a program to be executed by a storage system including a plurality of controllers and a plurality of drives,
the storage system being configured to be coupled to a host via a plurality of physical paths,
the storage system being configured to provide the host with a volume including storage areas of the plurality of drives,
the program causing one controller out of the plurality of controllers to execute the procedures of:
setting, to any one of the plurality of controllers, ownership which is a right to control IO to and from the volume; and
notifying, to the host, one of the plurality of physical paths that is coupled to one of the plurality of controllers to which the ownership is set, as a priority path for transmitting an IO request.
